(19) United States
(12) Patent Application Publication
(10) Pub. No.: US 2013/0216096 A1
(43) Pub. Date: Aug. 22, 2013

(54) INFORMATION PROCESSING APPARATUS, INFORMATION PROCESSING METHOD, PROGRAM, AND INFORMATION PROCESSING SYSTEM

(71) Applicant: Sony Corporation, (US)

(72) Inventor: Seiji Miyama, Kanagawa (JP)

(73) Assignee: SONY CORPORATION, Tokyo (JP)

(21) Appl. No.: 13/755,974

(22) Filed: Jan. 31, 2013

(30) Foreign Application Priority Data
Feb. 20, 2012 (JP) 2012-033840

(51) Int. Cl. G06K 9/36

(52) U.S. Cl. CPC G06K 9/36
USPC 382/103; 382/100

(57) ABSTRACT

There is provided an image management apparatus, in which an image conversion section is configured to generate a setup image, in a setup image format, within a first image pyramid structure for display, the setup image being converted from an object image, in an object image format, included within a second image pyramid structure in response to a request for the setup image.

### CROSS REFERENCES TO RELATED APPLICATIONS

The present application claims priority to Japanese Priority Patent Application JP 2012-033840 filed in the Japan Patent Office on Feb. 20, 2012, the entire content of which is hereby incorporated by reference.

### BACKGROUND

The present application relates to an information processing apparatus, an information processing method, a program, and an information processing system for displaying images obtained by a microscope.

In related art, there is known a system that digitizes images of an observation target obtained by an optical microscope, and appropriately uses the digital images corresponding to the purpose of use. As an example, Japanese Patent Application Laid-open No. 2011-112523 describes a system for use in the field of medical care, pathology, or others. With the system, using images of living cells, tissues, and organs obtained by optical microscopes, doctors and pathologists examine the living tissues and others, and diagnose patients, for example (see, for example, paragraphs 0002 and 0003 of Japanese Patent Application Laid-open No. 2011-112523).

The system described in Japanese Patent Application Laid-open No. 2011-112523 uses an image pyramid structure as shown in FIG. 2 therein. The image pyramid structure is an image group formed of the same images with different resolution, which are images of an observation target, and are obtained by an optical microscope. An arbitrary portion of an arbitrary image that is selected by a user from this image group is displayed. By using such an image pyramid structure, the user may feel as if he is observing the observation target while changing the observation magnification (see, for example, paragraphs 0032 to 0040 of Japanese Patent Application Laid-open No. 2011-112523).

### SUMMARY

As to the image obtained by the optical microscope as above, the data thereof is often large in capacity. That is, the image pyramid structure above expects the data of a plurality of images, for example. The image in a size of about 50×50 (Kpixel) is disposed at the bottom of the image pyramid structure as the largest image (described in paragraph 0033 of Japanese Patent Application Laid-open No. 2011-112523). The large-capacity image data as such is expected to be processed in a short time. That is, a process of converting various image formats into an optimal image format for display of images is also expected to be done in a short time, for example.

It is thus desirable to provide an information processing apparatus, an information processing method, a program, and an information processing system with which images obtained by a microscope may be processed in a short time for display.

According to an embodiment of the present application, there is provided an image conversion section configured to generate a setup image, in a setup image format, within a first image pyramid structure for display. In this embodiment the setup image is converted from an object image, in an object image format, included within a second image pyramid structure in response to a request for the setup image. This reduces image processing time so that an image with a relatively high resolution is processed for display only when requested by a user.

According to another embodiment of the present application, there is provided an information processing apparatus including a reception section, an acquisition section, a generation section, and a selection section.

The reception section receives an output request asking for output of at least one of a plurality of first object images. The first object images are images of an object obtained by a microscope, and the first object images are based on a first format and having different resolution.

The acquisition section acquires at least one second object image. The second object image is based on a second format different from the first format, and is obtained by the microscope.

The generation section may generate the first object images based on the acquired second object image for the output of the first object image responding to the output request.

The selection section selects at least one of the first object images generated by the generation section as a first setup image. The first setup image is generated irrespective of whether the output request is received. The remaining of the first object images are selected each as a second setup image generated in response to the reception of the output request.

With this information processing apparatus, a target of the output request includes a plurality of first object images based on the first format. These first object images are generated based on at least one of the second object images based on the second format. At this time, the generated first object images are partially selected for use as a first setup image(s), which are generated irrespective of whether the output request is received. The remaining of the first object images are selected as second setup images, which are generated in response to the reception of the output request. With the first and second setup images selected as appropriate, the time for generation and output of the first object images may be reduced. As a result, the images obtained by a microscope may be processed in a short time for display.

The selection section may make a selection of the first setup images to include at least any of the first object images having the lowest resolution.

The lowest-resolution first object image may be generated relatively in a short time. Moreover, the lowest-resolution first object image is requested relatively often for output. Accordingly, with the lowest-resolution first object image selected as the first setup image, the time for generation and output of the first object images may be reduced.

The selection section may select the second setup image to include at least any of the first object images having the highest resolution.

Generating the highest-resolution first object image takes a relatively long time. Moreover, the highest-resolution first object image is not often requested for output in its entirety. Therefore, by the highest-resolution first object image being selected as the second setup image, the time for generation and output of the first object images may be reduced.

The generation section may generate the first object images selected as the second setup images using a first generation pattern. The first generation pattern is based on the second object image with resolution equal to or higher than the resolution of the first object images.

This may improve the quality of the resulting first object images.

The generation section may generate the first object images selected as the second setup images using a second generation pattern. The second generation pattern is based on the second object image with resolution equal to or lower than the first object images.

This may reduce the time for generating the first object images.

The generation section may make a change between the first and second generation patterns in accordance with a mode related to the output of the first object image.

With the change of the first and second generation patterns as appropriate, the time for generation and output of the first object images may be reduced. Moreover, the resulting first object images may be improved in quality.

The acquisition section may acquire a plurality of second object images with different resolution.

With this information processing apparatus, a plurality of second object images varying in resolution are used as a basis to generate a plurality of first object images. These first object images may be generated and output in a short time.

The second object images may include a reference image for use as a reference, and a plurality of resolution-converted images. The resolution-converted images are results of converting resolution of the reference image.

As such, the second object images may include a reference image, and a plurality of resolution-converted images generated based on the reference image.

The second object images may be captured at different magnifications.

As such, the second object images may be captured at different magnifications.

An information processing method according to an embodiment of the present application includes receiving an output request asking for output of at least one of a plurality of first object images. The first object images are images of an object obtained by a microscope, and the first object images being based on a first format and having different resolution.

At least one second object image is acquired, which is obtained by the microscope, and is based on a second format different from the first format.

For the output of the first object image responding to the output request, the first object images are generated based on the acquired second object image.

At least one of the generated first object images is selected as a first setup image. The first setup image is generated irrespective of whether the output request is received. The remaining of the first object images are selected each as a second setup image generated in response to the reception of the output request.

Another information processing method according to an embodiment of the present application includes receiving a request for a setup image from an image browsing apparatus. The method also includes responsive to receiving the request, generating the setup image, in a setup image format, within a first image pyramid structure for display by converting the setup image from an object image, in an object image format, included within a second image pyramid structure.

A program according to an embodiment of the present application causes a computer to perform the information processing method.

An information processing system according to an embodiment of the present application includes an image browsing apparatus, and an image management server.

The image browsing apparatus includes a transmission section, and a display section.

The transmission section transmits an output request asking for output of at least one of a plurality of first object images. The first object images are images of an object obtained by a microscope, and the first object images are based on a first format and having different resolution.

The display section displays at least one of the first object images as a target of the output request.

The image management server includes a reception section, an acquisition section, a generation section, a selection section, and an image transmission section.

The reception section receives the output request provided by the transmission section of the image browsing apparatus.

The acquisition section acquires at least one second object image. The second object image is based on a second format different from the first format, and is obtained by the microscope.

The generation section may generate the first object images based on the acquired second object image for the output of the first object image responding to the output request.

The selection section selects at least one of the first object images generated by the generation section as a first setup image. The first setup image is generated irrespective of whether the output request is received. The remaining of the first object images are selected each as a second setup image generated in response to the reception of the output request.

The image transmission section transmits the first object images generated by the generation section to the image browsing apparatus.

As described above, according to the embodiments of the present application, images obtained by a microscope may be processed in a short time for display.

Additional features and advantages are described herein, and will be apparent from the following Detailed Description and the figures.

### BRIEF DESCRIPTION OF THE FIGURES

FIG. 1 is a diagram schematically showing an exemplary configuration of an image browsing system as an information processing system according to a first embodiment of the present application;

FIG. 2 is a diagram schematically showing a plurality of exemplary object images forming an image pyramid structure;

FIG. 3 is a diagram for illustrating a typical procedure to form an image group for the image pyramid structure;

FIG. 4 is a diagram schematically showing a first image pyramid structure according to the first embodiment;

FIG. 5 is a diagram schematically showing a second image pyramid structure according to the first embodiment;

FIG. 6 is a flowchart of exemplary import with the second image pyramid structure;

FIG. 7 is a schematic diagram for illustrating how to make setting of setup images;

FIG. 8 is a flowchart of an exemplary operation of the image browsing system in response to a user input of a browsing request;

FIG. 9 is a diagram schematically showing an exemplary GUI for input of an image browsing instruction;

FIG. 10 is a diagram schematically showing an exemplary GUI to be displayed on a display section when an image selection is made on a selection screen of FIG. 9;

FIG. 11 is a diagram schematically showing an observation screen after a user input of a zoom-in operation;

FIG. 12 is a schematic diagram for illustrating the operation of the image browsing system in response to the user input of the zoom-in operation;

FIG. 13 is a flowchart of exemplary dynamic format conversion according to a second embodiment of the present application;

FIG. 14 is a diagram schematically showing a modification example of the selection screen of FIG. 9; and

FIGS. 15A and 15B are each a diagram schematically showing another exemplary second image pyramid structure to be captured by an image management server.

These and other objects, features and advantages of the present disclosure will become more apparent in light of the following detailed description of best mode embodiments thereof, as illustrated in the accompanying drawings.

### DETAILED DESCRIPTION

Hereinafter, embodiments of the present application will be described with reference to the drawings.

### First Embodiment

[Configuration of Information Processing System]

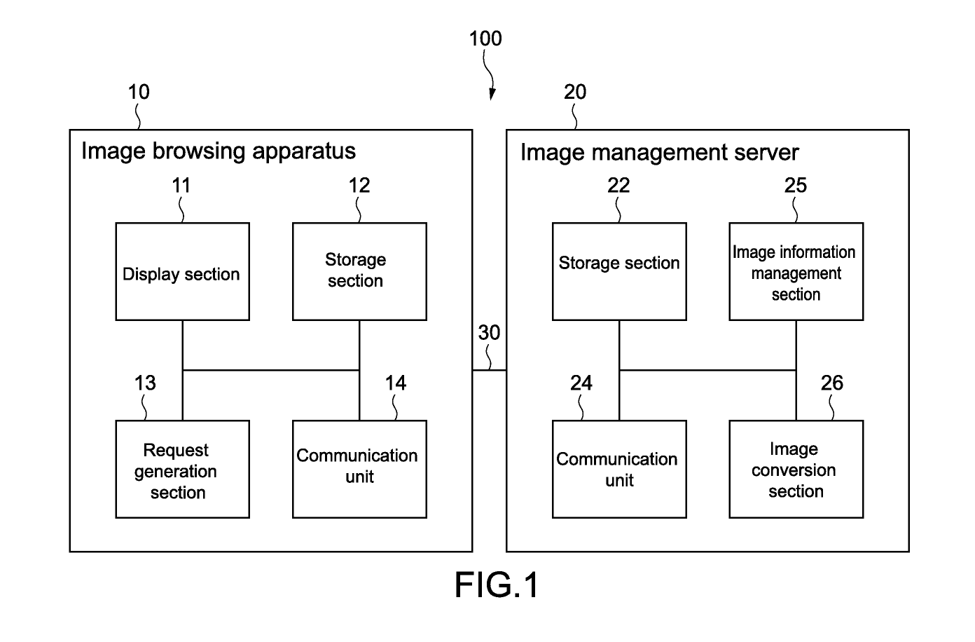

FIG. 1 is a diagram schematically showing an exemplary configuration of an image browsing system as an information processing system according to a first embodiment of the present application.

An image browsing system 100 includes an image browsing apparatus 10, an image management server 20, and a network 30. The image management server 20 manages images for browsing by the image browsing apparatus 10, and the network 30 connects together the image browsing apparatus 10 and the image management server 20.

The network 30 for use is exemplified by LAN (Local Area Network), and WAN (Wide Area Network). There is no restriction on the type of the network 30, and which protocol is to be used therewith, for example. That is, the network 30 may be WAN so that telepathology and telediagnosis may be implemented thereby, for example.

The image browsing apparatus 10 includes a display section 11, a storage section 12, a communication unit 14, and a request generation section 13. The display section 11 is a display device using a liquid crystal material, an EL (Electro-Luminescence) material, a CRT (Cathode Ray Tube), and others. A user browses images displayed on the display section 11.

The storage section 12 is a nonvolatile storage device, and is exemplified by an HDD (Hard Disk Drive), a flash memory, and any other solid-state memory.

The communication unit 14 is a modem, a router, or any other communication equipment, which is connectable to the network 30 exemplified above by LAN and WAN, and is used for communication with any other device. The communication unit 14 may perform either of cable communication or wireless communication.

The request generation section 13 generates an output request, which is transmitted to the image management server 20 via the communication unit 14. The output request includes information about a predetermined image being a request target. The details will be described later.

The image management server 20 includes a storage section 22, a communication unit 24, an image information management section 25, and an image conversion section 26. The storage section 22 and the communication unit 24 may be those similar to the storage section 12 and the communication unit 14 in the image browsing apparatus 10 described above.

The image conversion section 26 performs a process of format conversion on images stored in the storage section 22 and others. That is, images in the format suitable for any other image browsing system are converted in format to be suitable for the image browsing system 100, for example. The details will be described later.

The image information management section 25 manages information about the images stored in the storage section 22 and others. That is, the information managed by the image information management section 25 is about the images in any other format acquired from any other image browsing system, and about the images after the format conversion by the image conversion section 26, for example. The details will be described later.

The image browsing apparatus 10 and the image management server 20 are each a computer such as PC (Personal Computer). The information processing by these apparatuses is implemented by the cooperation between software and hardware resources. The software is exemplified by an application stored in a ROM (Read Only Memory) in the computer, and the hardware resources are exemplified by the PC. To be specific, the information processing is performed by a CPU (Central Processing Unit) loading a program to a RAM (Random Access Memory) for running. The program is software stored in the ROM, for example.

That is, the function blocks and the modules in the apparatuses are implemented by the CPU and others operating based on the program. The program is installed to each of the apparatuses via a recording medium, for example, and alternatively, may be installed over a global network, for example. For implementation of the function blocks and the modules, any predetermined hardware may be provided as appropriate.

Described next are images to be handled in the image browsing system 100 in this embodiment. The images to be handled in this embodiment are a plurality of object images, which are images of an object obtained by an optical microscope. The object images have different resolution, and form an image pyramid structure.

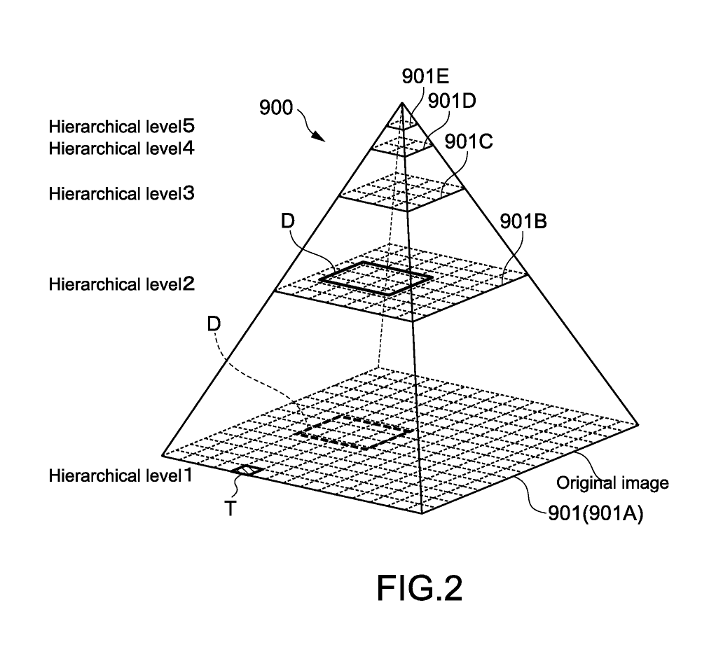

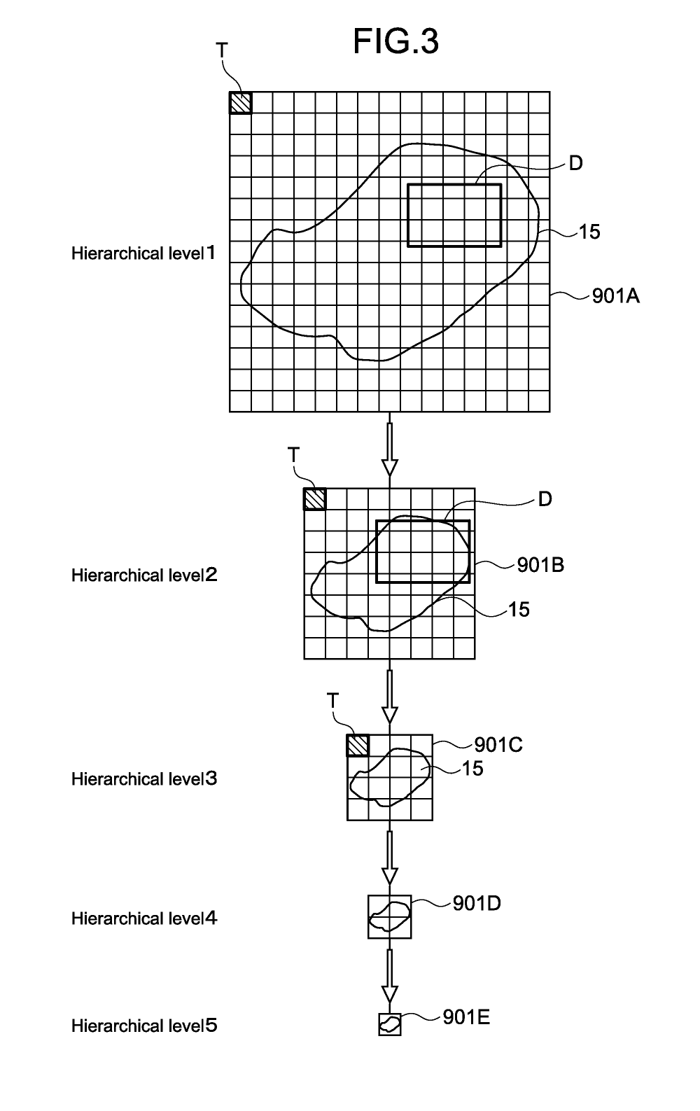

FIG. 2 is a diagram schematically showing a plurality of exemplary object images forming an image pyramid structure. An image pyramid structure 900 is an image group formed of the same object images 901 with different resolution, which are images of an object 15 (see FIG. 3), and are obtained by an optical microscope.

At the bottom of the image pyramid structure 900, an object image 901A largest in size is disposed, and at the top thereof, an object image 901E smallest in size is disposed. The largest-size object image 901A has the resolution of 50×50 (Kpixel), or of 40×60 (Kpixel), for example. The smallest-size object image 901E has the resolution of 256×256 (pixel), or of 512×512 (pixel), for example.

The image pyramid structure 900 of FIG. 2 has five hierarchical levels. As information about the hierarchical levels, hierarchical index values are set. In this embodiment, the hierarchical level at the bottom where the largest-size object image 901A is disposed is set as a hierarchical level 1. As shown in FIG. 2, the hierarchical index values are defined to increase in the direction of a reduction in resolution from the hierarchical level at the bottom. That is, the hierarchical index value of the object image 901E with the lowest resolution indicates a hierarchical level 5.

As to the object image 901 disposed at each hierarchical level, a predetermined area thereof is defined as a display area D. The display area D does not mean the size of the largest display area available in the display section 11, but means the entire display area in the display section 11 or a part thereof. The display area D may be set by a user as appropriate, for example.

FIG. 3 is a diagram for illustrating the typical procedure to form an image group for the image pyramid structure 900.

First of all, a digital image is made ready. This digital image is of an original image obtained by an optical microscope (not shown) at a predetermined observation magnification. This original image corresponds to the largest-size object image 901A located at the bottom of the image pyramid structure 900. That is, the original image is the object image with the highest resolution. Therefore, the image at the bottom of the image pyramid structure 900 for use is an image obtained by the optical microscope at a relatively high observation magnification.

Note that, generally in the field of pathology, the object 15 being an observation target includes living organs, tissues, and cells, or a thin slice cut therefrom. The object 15 on a slide glass is then read by a scanner apparatus (not shown) functioning as an optical microscope, and the resulting digital image is stored in the scanner apparatus or in any other storage apparatus.

As shown in FIG. 3, this scanner apparatus or a general-purpose computer (not shown) generates a plurality of object images 901 based on the largest-size object image 901A acquired as above. These object images 901 are generated by a stepwise reduction of the resolution of the object image 901A. The scanner apparatus or the general-purpose computer stores these object images 901 in units of “tile” being a unit of a predetermined size, for example. A tile T has the size of 256×256 (pixel) or 512×512 (pixel), for example.

In the image pyramid structure 900 formed as such, the largest-size object image 901A corresponds to a reference image. The remaining object images 901 correspond to a plurality of resolution-converted images, which are the results of resolution conversion performed on the reference image.

In this embodiment, the image pyramid structure is formed based on a first format, which is a format suitable for image browsing by the image browsing system 100. In the below, the image pyramid structure based on the first format is referred to as first image pyramid structure.

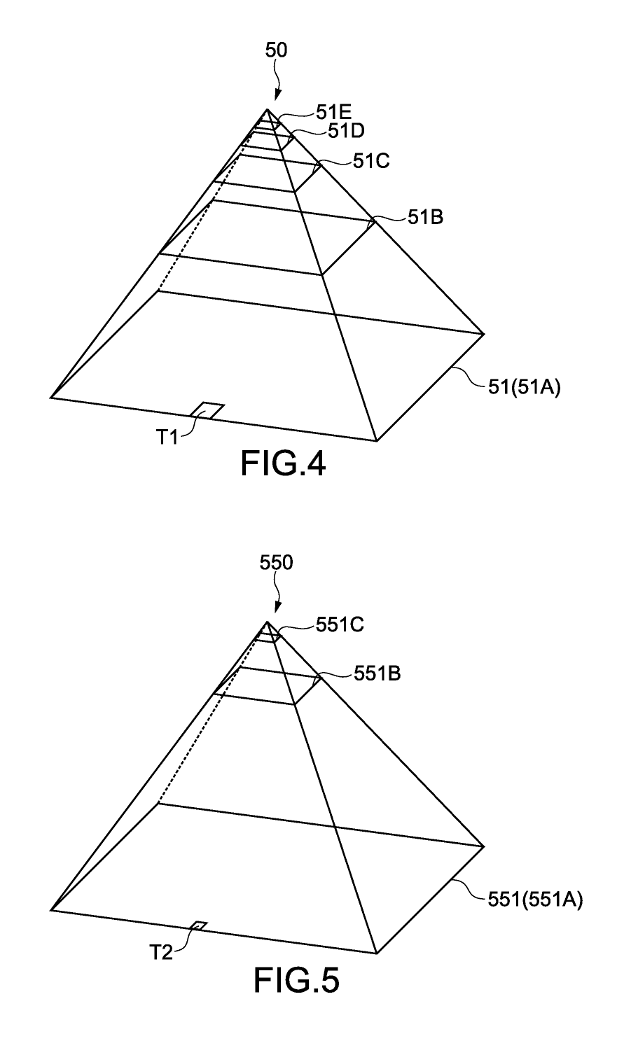

FIG. 4 is a diagram schematically showing a first image pyramid structure 50. The first image pyramid structure 50 in this embodiment is formed by five first object images 51 as below.

First object image 51A (8192×4096 (pixel)) (at the bottom)

First object image 51B (4096×2048 (pixel))

First object image 51C (2048×1024 (pixel))

First object image 51D (1024×512 (pixel))

First object image 51E (512×256 (pixel)) (at the top)

The first object images 51 of FIG. 4 are each stored in units of a tile image T1 of 512×512 (pixel). The first object image 51E at the top is stored as an image of the size described above. As a codec for compression/decompression of the tile images T1, JPEG (Joint Photographic Experts Group) is used.

For forming the first image pyramid structure 50 of FIG. 4, used is an image pyramid structure formed based on a second format, which is different from the first format. In the below, the image pyramid structure based on the second format is referred to as second image pyramid structure.

FIG. 5 is a diagram schematically showing a second image pyramid structure 550. The second image pyramid structure 550 in this embodiment is formed by three second object images 551 as below.

Second object image 551A (8192×4096 (pixel)) (at the bottom)

Second object image 551B (2048×1024 (pixel))

Second object image 551C (512×256 (pixel)) (at the top)

The second object images 551 of FIG. 5 are each stored in units of a tile image T2 of 256×256 (pixel). As a codec for compression/decompression of the tile images T2, JPEG 2000 is used.

By performing format conversion on this second image pyramid structure 550, the first image pyramid structure 50 is formed. This format conversion will be described in detail later. Herein, there is no restriction on the type of the codec.

Using a predetermined application, for example, the image browsing apparatus 10 operates as predetermined in response to the user's input operation. The application for use is exemplified by a Web browser.

As an example, the image browsing apparatus 10 transmits an output request to the image management server 20, asking for output of at least one of the first object images 51 in the first image pyramid structure 50. To be specific, the image browsing apparatus 10 transmits an output request asking for the tile image T1 located at the user-selected arbitrary portion in the first object image 51 having the user-selected arbitrary resolution.

The output request is transmitted via the communication unit 14 of the image browsing apparatus 10. This output request is received by the communication unit 24 of the image management server 20. The communication unit 14 and the CPU implement a transmission section according to the embodiment, and the communication unit 24 and the CPU implement a reception section according to the embodiment.

In the manner as above, any desired image is extracted from the first image pyramid structure 50. The user may thus feel as if he is observing the object 15 while changing the observation magnification. That is, the image browsing apparatus 10 functions as a virtual microscope. The virtual observation magnification herein actually corresponds to the resolution.

[Operation of Information Processing System]

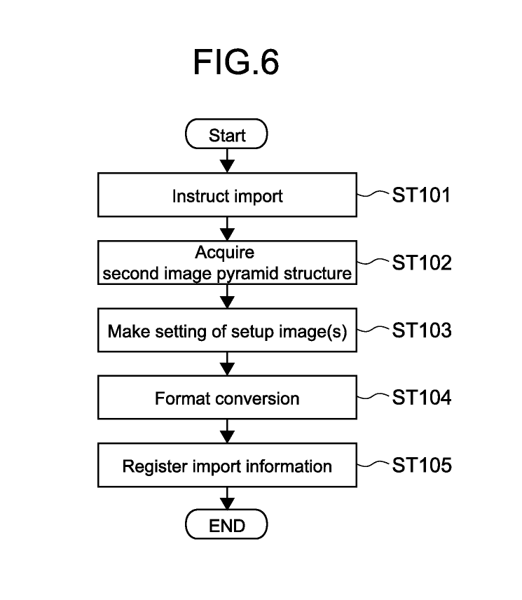

Described is the operation of the image browsing system 100 being the information processing system in this embodiment. FIG. 6 is a flowchart of exemplary import with the second image pyramid structure 550.

The image management server 20 receives an import instruction from the user via the communication unit 24 (step 101). In this embodiment, the import instruction input to the image browsing apparatus 10 is transmitted to the image management server 20 over the network 30.

With the application of operating the image browsing system 100, for example, a predetermined GUI (Graphical User Interface) is displayed on the display section 11 of the image browsing apparatus 10. The display section 11 displays an icon representing the second image pyramid structure 550, which is stored in any other server on the network 30, for example. The display section 11 also displays a folder for import indicating that the import is started. The user moves the icon to the import folder by drag and drop or others using an input device such as a mouse. With such an operation, the import instruction is input.

Note that how to input the import instruction is not restricted to the above, and any other arbitrary manner is also an option. Alternatively, the import instruction may be transmitted to the image management server 20 via any other apparatus. Still alternatively, the import instruction may be input directly to the image management server 20.

When receiving the import instruction, the image management server 20 acquires the second image pyramid structure 550 over the network 30 (step 102). The second image pyramid structure 550 is acquired via the communication unit 24, and then is stored in the storage section 22. The communication unit 24 and the CPU implement an acquisition section according to the embodiment.

Alternatively, the second image pyramid structure 550 may be acquired by the image management server 20 in advance. That is, when the second image pyramid structure 550 is acquired, the display section 11 of the image browsing apparatus 10 may display an icon of the second image pyramid structure 550, for example. The user may input an import instruction, and then the format conversion process may be performed on the second image pyramid structure 550 stored in the storage section 22.

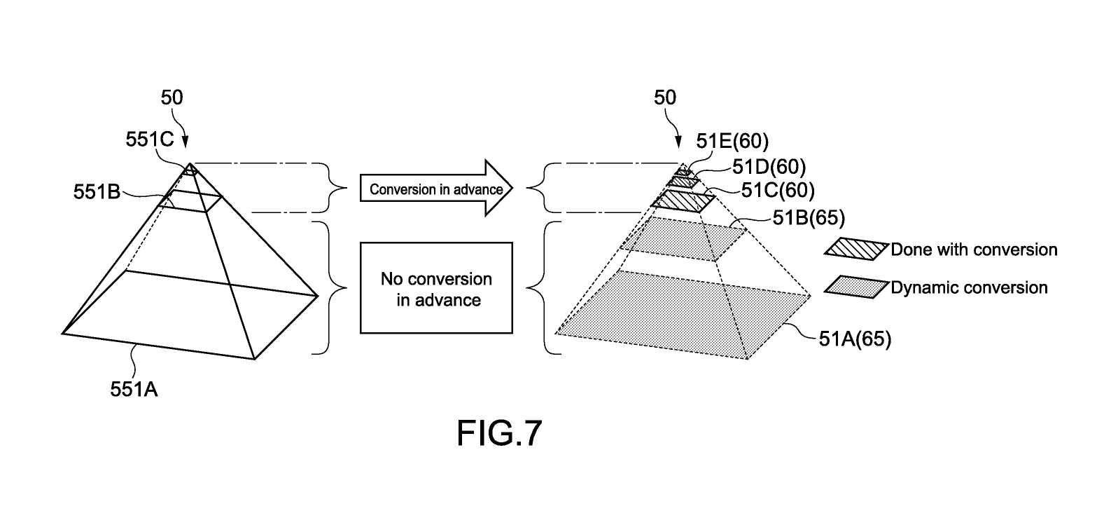

The image information management section 25 makes setting of setup images (step 103). FIG. 7 is a schematic diagram for illustrating how to make setting of setup images. The image information management section 25 functions as a selection section according to the embodiment.

In this embodiment, out of the first object images 51 generated by the format conversion process, at least one of the first object images 51 is selected as a first setup image 60. The remaining first object images 51 are selected as second setup images 65.

The first setup image 60 is an image that is generated irrespective of whether the output request from the user is received or not. That is, the first setup image 60 is subjected to format conversion in advance based on the second object images 551. Typically, the first setup image 60 is generated together with import of the second image pyramid structure 550.

The second setup image 65 is generated in response to the reception of the output request from the user. That is, the second setup image 65 is not subjected to format conversion in advance. Typically, the second setup image 65 is generated dynamically with reception of the output request.

As shown in FIG. 7, in this embodiment, the three first object images 51C to 51E with the lower resolution are selected as the first setup images 60. That is, out of the first object images 51, a selection of the first setup images 60 is so made as to at least include the first object image 51E with the lowest resolution.

Also in this embodiment, the two first object images 51A and 51B with the higher resolution are selected as the second setup images 65. That is, out of the first object images 51, a selection of the second setup images 65 is so made as to at least include the first object image 51A with the highest resolution.

The selection of the first and second setup images 60 and 65 may be set as appropriate. That is, a user instruction provided via the image browsing apparatus 10 or others may set which of the first object images 51 are to be selected as the first and second setup images 60 and 65. Alternatively, such setting may be made automatically based on information about the resolution of each of the first object images 51 generated by format conversion, for example. That is, with the setting, any of the first object images 51 with the resolution lower than a predetermined value may be selected as the first setup image(s) 60, for example.

The image conversion section 26 performs format conversion (step 104). The image conversion section 26 may generate the first object images 51 based on acquired one or more second object images 551 to output the first object image(s) 51 responding to the output request from the user. That is, the image conversion section 26 functions as a generation section according to the embodiment.

In step 104 in the import with the second image pyramid structure 550, the first object images 51C to 51E set as the first setup images 60 are generated by format conversion. In this embodiment, generated is the first object image 51C (2048×1024 (pixel)) based on the second object image 551B (2048×1024 (pixel)). The format conversion to be performed includes decoding of the second object image 551B and encoding by JPEG.

The first object image 51C generated as above is subjected to resolution conversion, so that the first object image 51D (1024×512 (pixel)) is generated. The first object image 51E with the lowest resolution (512×256 (pixel)) is generated by reducing the resolution of the first object image 51C or that of 51D. Alternatively, the first object image 51E may be generated based on the second object image 551C (512×256 (pixel)). As to the format conversion process for generating the first object images 51C to 51E, any arbitrary method (algorithm) may be used.

Information about import is registered (step 105). In this embodiment, the following information is registered as the import information. The import information is stored in the storage section 22.

The storage location of a file related to the first image pyramid structure 50 (a file storing the first object images 51C to 51E), e.g., path information

The storage location of a file related to the second image pyramid structure 550

The number of hierarchical levels of the first image pyramid structure 50 (5 in this embodiment)

The index of the hierarchical level(s) expected for dynamic format conversion (the hierarchical levels 1 and 2 in this embodiment)

Information about the Second Format (Exemplified Below)

The number of hierarchical levels of the second image pyramid structure 550, and the size ratio between the hierarchical levels

Information about resolution of each of the second object images 551

Size of the tile image T2 of the second object images 551, and information about codec (256×256 (pixel), and JPEG 2000 in this embodiment)

The information about the second format may be read as appropriate for use from the metadata portion of the file related to the second image pyramid structure 550. The import information for registration is not restricted to those described above. That is, the information related to the first format may be registered as the import information, for example. Typically, the information about the first format is stored in advance. Other than this, various other information may be registered as the import information, e.g., information about hierarchical levels done with format conversion.

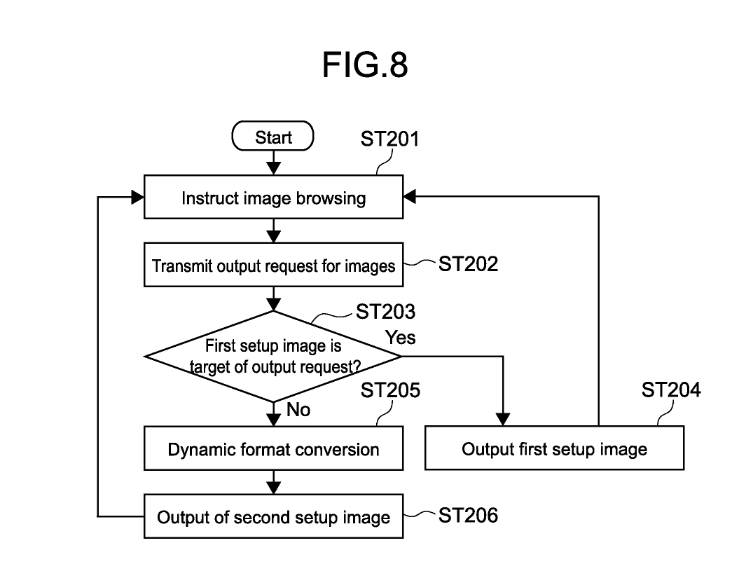

FIG. 8 is a flowchart of an exemplary operation of the image browsing system 100 in response to a user input of a browsing request.

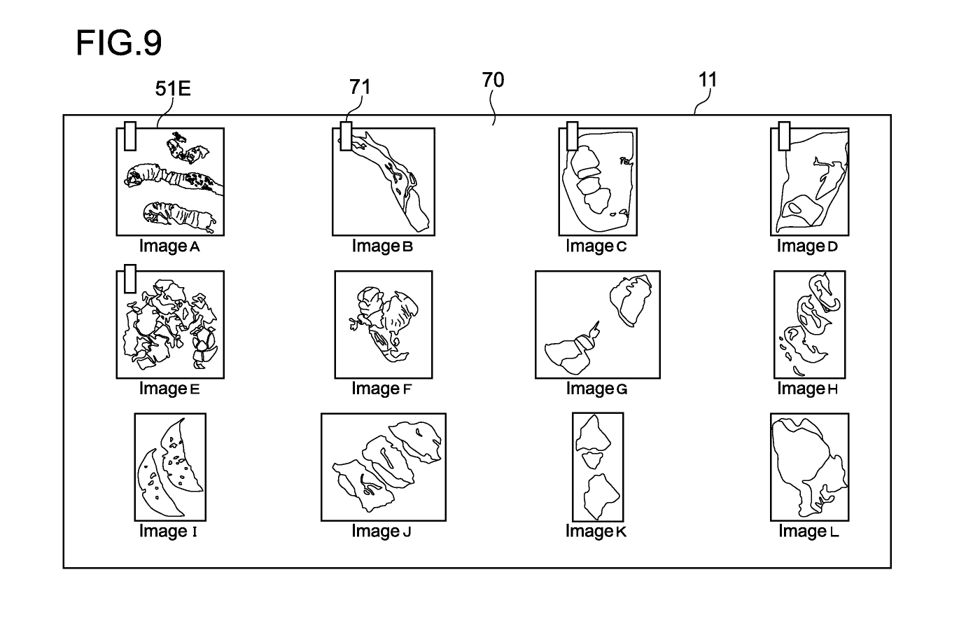

The user makes an input of instruction for image browsing (step 201). FIG. 9 is a diagram schematically showing an exemplary GUI for input of the instruction for image browsing.

As shown in FIG. 9, in this embodiment, the display section 11 of the image browsing apparatus 10 displays a selection screen 70 for an image selection for browsing. The selection screen 70 displays thumbnails of twelve images A to L. These twelve images are each done with the import of FIG. 6. That is, for each of the images A to L, the file related to the first image pyramid structure 50 is stored at a predetermined address.

The thumbnail-displayed images A to L on the selection screen 70 are each the first object image 51E with the lowest resolution. For generating the selection screen 70, in this embodiment, the image browsing apparatus 10 thus transmits an output request for such first object images 51E to the image management server 20. In response to the output request, the image management server 20 transmits the first object images 51E to the image browsing apparatus 10. This procedure corresponds to processes of steps 202 to 204 in FIG. 8, which will be described later.

The first object images 51 are transmitted via the communication unit 24 of the image management server 20. The communication unit 24 and the CPU implement an image transmission section according to the embodiment.

By the application or others in the image browsing apparatus 10, the selection screen 70 of FIG. 9 is generated, and then is displayed on the display section 11. The user may make an image selection for browsing from the first object images 51E displayed on the selection screen 70.

For generating the lowest-resolution first object images 51E, as described above, used are the images with the relatively low resolution, e.g., the lowest-resolution second object images 551C. This thus allows the first object images 51E to be generated in a relatively short time. Moreover, as exemplified in the thumbnail display on the selection screen 70 of FIG. 9, the lowest-resolution first object images 51E are requested relatively often for output. Accordingly, with the lowest-resolution first object images 51E selected and generated in advance as the first setup images 60, the time to be taken for generation and output of the first object images 51 may be reduced.

In the field of medical care, with simple cases, only the low-resolution images are often observed to make a diagnosis without observing the high-resolution images, for example. Therefore, generating the low-resolution first object images 51C to 51E in advance often leads to better efficiency.

As shown in FIG. 9, the user may add an annotation 71 on any predetermined image. That is, an image with greater importance is added with the annotation 71, for example. Alternatively, an image that has been observed may be added with the annotation 71. With the addition of the annotation 71 as such, the images A to L may be observed with the ease of operation.

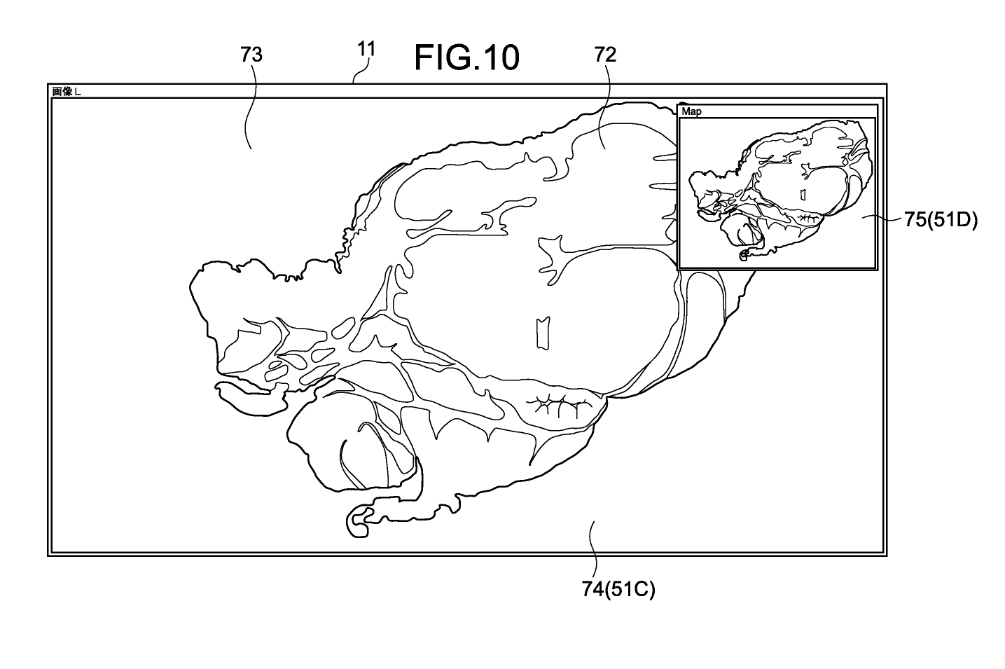

FIG. 10 is a diagram schematically showing an exemplary GUI to be displayed on the display section 11 when an image selection is made on the selection screen 70 for browsing. Exemplified herein is a case of selecting the first object image 51E as the image L. The display section 11 displays an observation screen 73 for observation of an object 72 of the image L. The observation screen 73 of FIG. 10 shows the image L after being rotated clockwise by 90 degrees.

For generating the observation screen 73, in step 202, an output request for the first object images 51C and 51D is transmitted to the image management server 20. The first object images 51C and 51D are the first object images 51 having the second and third lowest resolution, respectively.

The output request includes information about the hierarchical levels of the images requested for output, information about the size of the display area D, information about the coordinates, and others. Therefore, the output request for the first object images 51C and 51D includes information about the hierarchical levels 3 and 4.

The information about the size of the display area D and the coordinates in the output request mainly represents the tile image T1 expected for output. In this example, the first object images 51C and 51D are displayed in their entirety. Accordingly, for use as the information about the size of the display area D, the first object images 51C and 51D are each defined by size.

As to the coordinate information, used is the information about the coordinates of the tile image T1 located at the uppermost left in the display area D. In this example, the coordinate information is about the coordinates of the tile image T1 at the upper left in each of the first object images 51C and 51D. In this embodiment, the coordinates are set with the origin point being the point at the upper left in each of the images. The coordinates at the center of each of the tile images T1 are set as the coordinates of the tile image T1. There is no restriction on the type of coordinate systems, and how the coordinates are set in the tile images T1.

The coordinate information may include coordinates of the display area D. These coordinates may be used as a basis to calculate as appropriate the tile images T1 in the display area D.

A determination is made whether the output request is made for the first object images 51 having been selected as the first setup images 60 (step 203). This determination is made by the image information management section 25 based on the information about the hierarchical levels, for example. The first object images 51C and 51D are those having been selected as the first setup images 60. The procedure thus goes to step 204 with the determination of Yes in step 203.

In step 204, the first object images 51C and 51D are output, which have been selected and generated in advance as the first setup images 60. The first object images 51C and 51D are transmitted from the image management server 20 to the image browsing apparatus 10. In the image browsing apparatus 10, the first object images 51C and 51D output as above are used to generate the observation screen 73 of FIG. 10.

As shown in FIG. 10, the observation screen 73 includes a main image 74, and a MAP image 75. The main image 74 is displayed entirely on the display section 11, and the MAP image 75 is displayed at the upper right corner of the display section 11. The main image 74 is zoomed in and out as appropriate in response to a user instruction. The main image 74 is also moved as appropriate in response to a user instruction. In this example, the first object image 51C is displayed as the main image 74.

The MAP image 75 indicates which part of the first object image 51 is displayed as the main image 74. In this example, the first object image 51D is displayed as the MAP image 75.

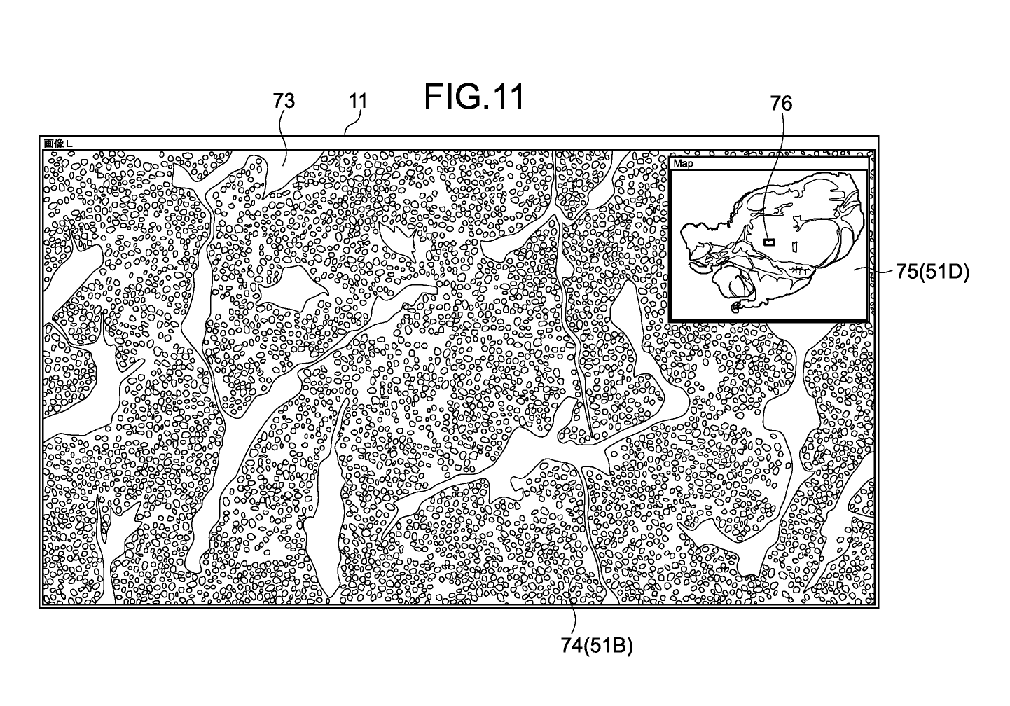

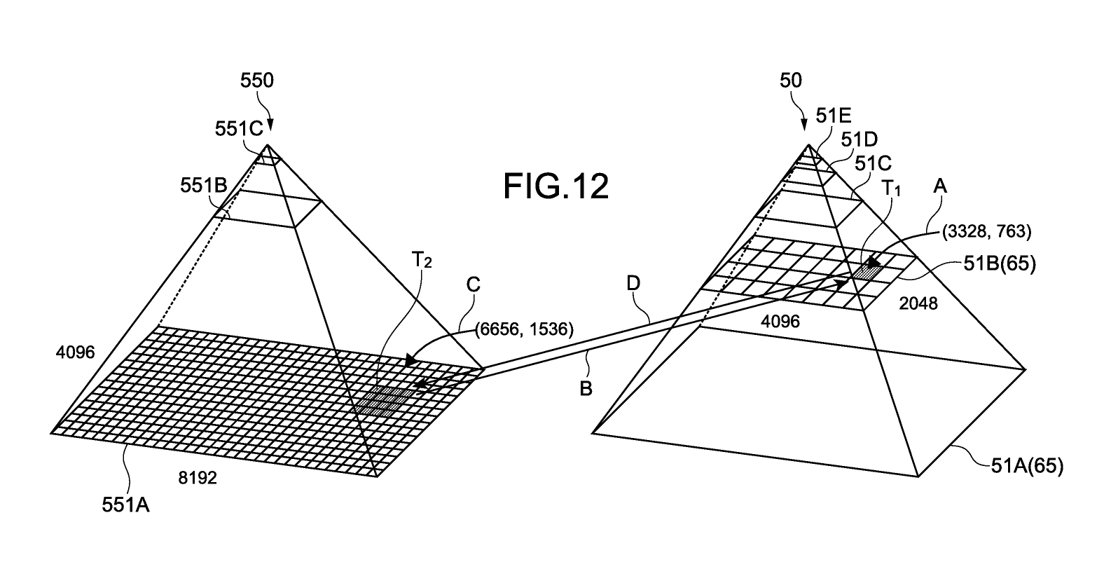

FIG. 11 is a diagram schematically showing the observation screen 73 after a user input of a zoom-in operation. FIG. 12 is a schematic diagram for illustrating how the image browsing system 100 operates in response to the user input of the zoom-in operation.

When the wheel of a mouse is operated, for example, a zoom-in or -out operation is input with respect to the main image 74. The zoom-in operation at this time corresponds to an instruction for browsing of the first object images 51 with the higher resolution (step 210).

Based on the user's zoom-in operation, an output request is generated, and then is transmitted to the image management server 20 (step 202). In this embodiment, as shown in FIG. 12, transmitted is an output request for the tile image T1 at the coordinates of (x, y)=(3328, 763) in the first object image 51B (4096×2048 (pixel)) in the hierarchical level 2 (arrow A).

The determination process in step 203 of FIG. 8 is then performed. The first object image 51B in the hierarchical level 2 has been set as the second setup image 65. The procedure thus goes to step 205 with the determination of No in step 203. In step 205, the tile image T1 in the first object image 51B requested for output is generated by dynamic format conversion.

The image conversion section 26 of the image management server 20 reads the import information stored in the storage section 22. The image conversion section 26 determines whether or not the second image pyramid structure 550 includes the hierarchical level equivalent to the hierarchical level 2 in the first image pyramid structure 50. That is, determined is whether the second image pyramid structure 550 includes the second object image 551 sharing the same resolution as the first object image 51B, for example.

In this example, the second image pyramid structure 550 does not include the hierarchical level equivalent to the hierarchical level 2 in the first image pyramid structure 50. Therefore, the image conversion section 26 selects any other hierarchical level close to the hierarchical level equivalent to the hierarchical level 2. In this embodiment, the image conversion section 26 finds any other hierarchical level in the direction of an increase in resolution. That is, selected is the second object image 551 whose resolution is higher than that of the first object image 51B, for example. As a result, the second object image 551A (8192×4096 (pixel)) in the hierarchical level 1 in the second image pyramid structure 550 is selected as the image for generating the first object image 51B (arrow B).

The image conversion section 26 calculates the tile image T2 to be a conversion target in the second object image 551A. The tile image T2 calculated as such corresponds to the tile image T1 being the target of the output request from the image browsing apparatus 10. As an example, the tile image T2 being the conversion target is calculated based on the resolution of the first object image 51B, and the coordinates of the tile image T1. Other than this, the tile image T2 may be calculated as appropriate based on the information in the output request, e.g., information about the display area D, and information about the coordinates.

As shown in FIG. 12, calculated is the tile image T2 at the coordinates of (x, y)=(6656, 1536). Together with this tile image T2, 16 other tile images T2 are calculated (arrow C), including four tile images T2 adjacent thereto in the×direction, and four tile images T2 adjacent thereto in the y direction.

The image conversion section 26 performs the format conversion process on the 16 tile images T2 calculated as the conversion target. The tile images T2 being JPEG-2000 images are decoded, thereby being zoomed out to be one half (area ratio of 1:4). As a result, the image of 512×512 (pixel) is generated. The generated image is then encoded by JPEG, so that the tile image T1 being the target of the output request is generated (arrow D).

In step 206 of FIG. 8, the generated second setup image 65 (the first object image 51B) is output. In this example, the generated tile image T2 is transmitted to the image browsing apparatus 10. As shown in FIG. 11, in the image browsing apparatus 10, the received tile image T2 is displayed on the observation screen 73 as the main image 74. The MAP image 75 includes a framed image 76 indicating the position of the main image 74.

As described above, with the image browsing system 100 including the image management server 20 according to this embodiment, the target of the output request includes the first object images 51 based on the first format. The first object images 51 are generated based on at least one of the second object images 551 based on the second format. At this time, a part of the generated first object images 51 is selected as the first setup image(s) 60, which are generated irrespective of whether the output request is received. The remaining first object images 51 are selected as the second setup images 65, which are generated in response to the reception of the output request. With the first and second setup images 60 and 65 selected as appropriate, the time to be taken for generation and output of the first object images 51 may be reduced. This allows the images obtained by a microscope to be processed and displayed in a short time.

That is, by dynamically generating a part of the first object images 51 in the first image pyramid 50, the image data may be output at a higher speed than a case of dynamically generating the entire image data at the time of output thereof, for example. Moreover, the images to be generated in advance at the time of import are also a part of the first object images 51 in the first image pyramid structure 50. Therefore, the import is completed at a higher speed.

That is, at the time of import, and at the time of dynamic conversion, the first image pyramid structure 50 is not entirely formed. This thus allows browsing immediately after import of any other format. The not-yet-converted portion of the first image pyramid structure may be dynamically generated when a request comes for browsing. This reduces the load of the dynamic conversion process at the time of browsing compared with the case of dynamically generating entirely the first image pyramid structure 50. Accordingly, the output is made with a good response to the request for browsing, so that the user is able to browse the first object images 51 at a high speed with the ease of operation.

In this embodiment, the second setup images 65 are selected from the first object images 51 so as to include at least the highest-resolution first object image 51A. The highest-resolution first object image 51A is generated based on the highest-resolution second object image 551A. Therefore, generating the first object image 51A takes a relatively long time. Moreover, the highest-resolution first object image 51A is not often requested for output in its entirety. That is, the tile images T1 in the first object image 51A are not often requested for output in their entirety. Therefore, as to the first object images 51A, generating the tile images T1 as appropriate upon reception of an output request often leads to better efficiency. As such, with the highest-resolution first object image 51A selected as the second setup image 65, the time to be taken for generation and output of the first object images 51 may be reduced.

In this embodiment, the image management server 20 acquires a plurality of second object images 551 varying in resolution. These second object images 551 form the second image pyramid structure 550. As described above, the highest-resolution second object image 551A is a reference image, and based on this reference image, the remaining second object images 551 are generated. With such second object images 551 used as a basis, the first object images 51 are generated and output in a short time.

### Second Embodiment

Described is an image browsing system according to a second embodiment of the present application. In the following description, a description of the same configuration and function as those according to the image browsing system 100 described in the first embodiment will be omitted or simplified.

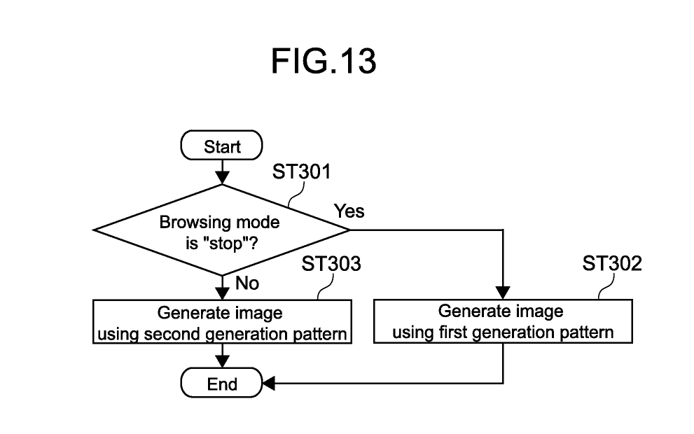

In this second embodiment, the image conversion section in the image management server performs dynamic format conversion differently from that in the first embodiment. That is, the first object images 51 selected as the second setup images 65 are generated differently from those in the first embodiment. Herein, the dynamic format conversion is described in detail. FIG. 13 is a flowchart of exemplary dynamic format conversion according to the second embodiment.

In this embodiment, a determination is made about a mode related to output of the first object images 51. This mode is related to how the main image 74 is browsed on the observation screen 73. In the below, the mode related to output of the first object images 51 is referred to as browsing mode.

In this embodiment, the browsing mode includes two modes of move and stop. In the move mode, the main image 74 displayed on the observation screen 73 is moved by, for example, the user's scrolling of the mouse. In the stop mode, the main image 74 is not moved. The stop mode also includes the zoom-in and -out operation with no movement of the main image 74.

The determination about a browsing mode is made based on an output request coming from the image browsing apparatus 10. In the move mode, for example, the output requests successively come with different coordinate information. On the other hand, in the stop mode, the output requests do not continuously come, or the output requests successively come with the information different only about the size of the display area D. Based on such a type of the output request, the determination is made about the browsing mode.

In this embodiment, the image conversion section 26 determines the browsing mode after receiving the output request. Alternatively, for determining the browsing mode, a module or others may be provided as another block.

A determination is made about whether the browsing mode is “stop” or not (step 301). When the determination is made that the browsing mode is “stop” (Yes), using the first generation pattern, the first object images 51 selected as the second setup images 65 are dynamically generated (step 302).

The first generation pattern is the generation method described in the first embodiment. That is, the first generation pattern is to generate the first object images 51 based on the second object images 551 whose resolution is equal to or higher than that thereof This accordingly improves the quality of the resulting first object images 51.

When the browsing mode is “stop”, it is considered that the user often views the main image 74. Therefore, with the better-quality first object images 51 generated using the first generation pattern, the user is allowed to observe the images with high precision.

When the determination is made that the browsing mode is not “stop” (No), using the second generation pattern, the first object images 51 selected as the second setup images 65 are dynamically generated (step 302).

The second generation pattern is to generate the first object images 51 based on the second object images 551 whose resolution is equal to or lower than that thereof The first object images 51 are generated by enlarging as appropriate the lower-resolution second object images 551. This accordingly reduces the time for generating the first object images 51.

When the browsing mode is not “stop” but “move”, it is considered that the user often searches for the main image 74 to observe. Therefore, with the first object images 51 generated at a high speed using the second generation pattern, the user is allowed to perform the search operation at a high speed. In the move mode, reducing the time for generating the first object images 51 is given a higher priority than improving the quality thereof.

As described above, in this embodiment, the browsing mode related to output of the first object images 51 is used as a basis for a change of the first and second generation patterns. With the change of the first and second generation patterns as appropriate, the time for generation and output of the first object images 51 may be reduced. Moreover, the resulting first object images 51 may be improved in quality.

Alternatively, the change of the first and second generation patterns may be made as appropriate in response to a user instruction. Still alternatively, the browsing mode related to output of the first object images 51 is not restricted to that described above, and may be set as appropriate.

### Modification Examples

The embodiments according to the present application are not restricted to those described above, and numerous other variations thereof may be devised.

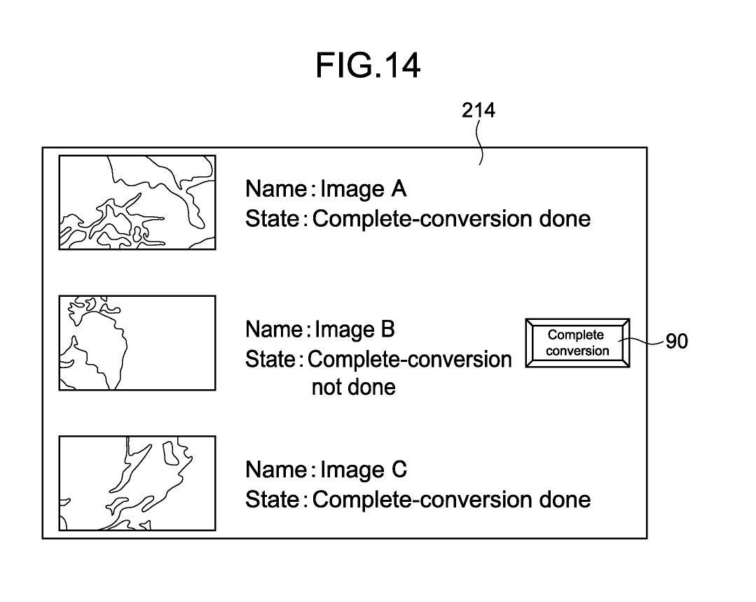

For example, FIG. 14 is a diagram schematically showing a modification example of the selection screen 70 of FIG. 9. A selection screen 214 of FIG. 14 displays information about the conversion state of images for browsing. The conversion state of images for browsing includes two states of “complete-conversion done” and “complete-conversion not done”.

With the state of “complete-conversion done”, every hierarchical level has been completely converted in the first image pyramid structure related to the thumbnail-displayed first object images. That is, all the first object images in the first image pyramid structure are already generated by format conversion.

In FIG. 14, images A and C have been converted in every hierarchical level. Therefore, even for generating the highest-resolution first object image, with no dynamic format conversion, any predetermined tile image of the already-generated first object image is output, for example.

The state of “complete-conversion not done” is the state described in the embodiments above, i.e., the state in which the first object images selected as the second setup images are not yet generated. In FIG. 14, the image B is in such a state. The image B displays a UI (User Interface) button of complete conversion. A complete-conversion button 90 is a UI for the user to perform complete conversion.

When the complete-conversion button 90 is depressed by a user operation, a complete-conversion request is transmitted from the image browsing apparatus to the image management server. When receiving the complete-conversion request, the image management server performs format conversion on the first object images selected as the second setup images. As a result, the format conversion is performed on every hierarchical level. Herein, in the complete-conversion process, image browsing may be possible by dynamic conversion.

The image browsing apparatus asks for output of the lowest-resolution first object image for generating the selection screen 214. At this time, an output request for information about the conversion state is also transmitted to the image management server. The image browsing apparatus generates the selection screen 214 based on the image data provided by the image management server, and the information about the conversion state.

As such, for each image, a selection may be made as appropriate between the states of “complete-conversion done” and “complete-conversion not done”. With the state explicitly displayed, the process for the user's observation is performed with more ease. Moreover, because the user is allowed to select whether or not to perform complete conversion, the operation according to the observation purpose may be performed as appropriate. That is, with a high-priority image expected for close observation, the user may operate to select the state of “complete-conversion done,” for example. After the completion of the complete conversion on the image, because the image is not expected for dynamic conversion any more, the browsing may be performed at a high speed. Moreover, because any other format file is not expected to be stored, the HDD capacity is made available for storage.

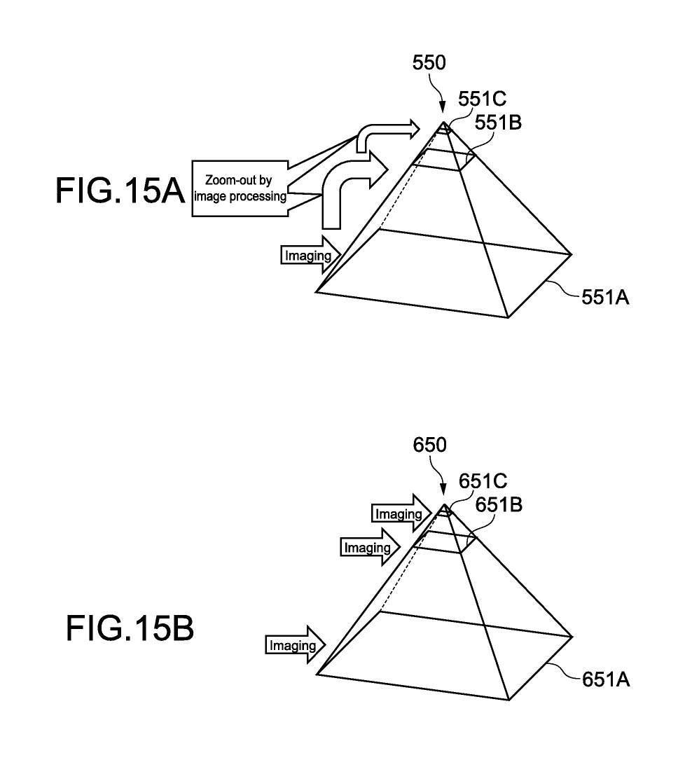

FIGS. 15A and 15B are each a diagram schematically showing another exemplary second image pyramid structure to be captured by the image management server based on another format. FIG. 15A shows the second image pyramid structure 550 described in the embodiments above. That is, a reference image is the highest-resolution second object image 551A, and based on this reference image, the remaining second object images 551 are generated.

FIG. 15B shows another exemplary second image pyramid structure. A plurality of second object images 651 in a second image pyramid structure 650 are those captured at various magnifications. That is, the second image pyramid structure 650 is formed by various images of an object captured at various magnifications. In hierarchical levels, second object images 651A to 651C are generated as a piece of image by a stitching process as appropriate but vary in resolution, for example.

There is no restriction on the structure of and how to form the second image pyramid structure to be captured as described above. Information about each hierarchical level is stored as import information, and based on the import information, a plurality of first object images may be generated.

Alternatively, for generating a plurality of first object images, captured may be only a piece of second object image. That is, the second image pyramid structure does not have to be captured. As an example, a piece of second object image may be captured as an original image with the highest resolution. This second object image may be used as a basis to generate a plurality of first object images.

In every hierarchical level in the first image pyramid structure, format conversion may be dynamically performed. That is, all of the first object images may be selected as the second setup images. In this case, the time to be taken for import may be reduced. Moreover, the first object images to be selected as the first and second setup images are arbitrary.

In the above, the image displayed on the selection screen is the one with the lowest resolution. The image with the second lowest resolution is displayed thereon as a MAP image, and the image with the third lowest resolution is displayed as a main image immediately after image selection. Alternatively, these images used as such may be each generated by a zoom-in and -out operation or others based on a low-resolution image. That is, a thumbnail image may be generated as appropriate for display on the selection screen, for example. Also in this case, the processing time is short because the low-resolution images are the processing target.

In the above, the tile image T1 is selected as the display area D in an output request. That is, the display area D has the same size as the tile image T1. However, this is not restrictive, and the tile images T1 in the display area D may be calculated as appropriate, and the tile images T1 may be dynamically generated as appropriate.

The dynamically-generated first object images (the tile images T1 expected for use) may be retained by being stored in a temporary cache. This eliminates the process of dynamic conversion again when the incoming output request is the same as before. As a result, the processing time may be reduced.

A selection between the first and second setup images may be performed based on historical information. When there are many requests for browsing of the high-resolution first object images, for example, the high-resolution first object images may be selected as the first setup images. The statistical information about the user's browsing in the past may be used as appropriate.

In the above, the image browsing system includes one image browsing apparatus, and one image management server. However, the number of the image browsing apparatuses and the number of the image management servers in the image browsing system as the embodiment of the present application are not restricted. Moreover, the one-to-one relationship is not expected for the image browsing apparatus and the image management server.

The information processing apparatus according to the embodiments for use may be a computer or others having the functions of the image browsing apparatus, and the functions of the image management server described above. Moreover, for use as the information processing apparatus according to the embodiments, the image browsing apparatus and the image management server may be connected directly not over a network.

The present application is not restricted for use in the field of medical care, pathology, and others, and is applicable to material observation in any other field, for example.

The present application is also in the following structures.

(1) An image management apparatus comprising:

an image conversion section configured to generate a setup image, in a setup image format, within a first image pyramid structure for display, the setup image being converted from an object image, in an object image format, included within a second image pyramid structure in response to a request for the setup image.

(2) The image management apparatus according to (1), wherein the image conversion section is configured to generate a second setup image, in the setup image format, within the first image pyramid structure for display, the second setup image being converted from a second object image, in the object image format, included within the second image pyramid structure prior to the request for the setup image.

(3) The image management apparatus according to (1) or (2), wherein the setup image has a higher resolution than the second setup image.

(4) The image management apparatus according to any one of (1) to (3), further comprising an information management section configured to store information indicative that the second setup image is to be generated prior to the request and the setup image is to be generated responsive to the request.

(5) The image management apparatus according to any one of (1) to (4), wherein the information indicative that the second setup image is to be generated prior to the request includes a resolution threshold that indicates that setup images with resolutions less than the resolution threshold are to be generated prior to the request being received.

(6) The image management apparatus according to any one of (1) to (5), wherein the image conversion section is configured to:

receive the object image from an acquisition section; and

generate the second image pyramid structure by creating at least the second object image by reducing a resolution of the object image and storing the object image and the second object image to the second image pyramid structure.

(7) The image management apparatus according to any one of (1) to (6), wherein the object image is received responsive to an output from a digital optical microscope.

(8) The image management apparatus according to any one of (1) to (7), wherein the image conversion section is configured to:

receive the object image and the second object image from an acquisition section; and

store the object image and the second object image to the second image pyramid structure.

(9) The image management apparatus according to any one of (1) to (8), wherein the request includes an instruction to view at least a portion of the setup image at a higher resolution than the second setup image, wherein the portion is specified by coordinates of the second setup image.

(10) The image management apparatus according to any one of (1) to (9), wherein the image conversion section is configured to generate the setup image from only the selected portion of the second setup image.

(11) The image management apparatus according to any one of (1) to (10), wherein the image conversion section is configured to:

determine a client device is in a move browsing mode based information included within the request;

generate the second object image from the object image, the second object image having a greater resolution than the object image; and

generate the second setup image from the second object image before the request and the setup image from the second object image after the request.

(12) The image management apparatus according to any one of (1) to (11), wherein the information included within the request includes coordinate information.

(13) The image management apparatus according to any one of (1) to (12), wherein the image conversion section is configured to:

determine a client device is in a stop browsing mode based information included within the request;

generate the second object image from the object image, the second object image having a lower resolution than the object image; and

generate the second setup image from the second object image before the request and the setup image from the second object image after the request.

(14) The image management apparatus according to any one of (1) to (13), wherein the image conversion section is configured to generate the setup image and the second setup image upon a conversion request from a client device.

(15) The image management apparatus of according to any one of (1) to (14), wherein the image conversion section is configured to generate a third setup image by reducing a resolution of the second setup image prior to the request.

(16) The image management apparatus according to any one of (1) to (15), wherein the image conversion section is configured to generate the setup image by:

identifying an object image within the second image pyramid structure that has a greater resolution than the setup image, the identified object image being the object image;

reducing a resolution of the object image to a resolution specified for the setup image in the request; and

converting the reduced resolution version of the object image to the setup image format.

(17) The image management apparatus according to any one of (1) to (16), wherein the image conversion section is configured to identify the object image by determining which object image within the second image pyramid structure has a nearest resolution to a resolution of the requested setup image.

(18) A system comprising:

an image management apparatus configured to generate a setup image, in a setup image format, within a first image pyramid structure for display, the setup image being converted from an object image, in an object image format, included within a second image pyramid structure in response to a request for the setup image; and

an image browsing apparatus configured to:
transmit a request to the image management server for the setup image;
receive the setup image from the image management server; and
display the setup image.

(19) An image browsing apparatus comprising:
a request generation section configured to transmit a request for a setup image, in a setup image format, within a first image pyramid structure, the request causing the setup image to be converted from an object image, in an object image format, included within a second image pyramid structure; and

a display section configured to display the received setup image.

(20) A method to generate a setup image comprising:

receiving a request for a setup image from an image browsing apparatus; and

responsive to receiving the request, generating the setup image, in a setup image format, within a first image pyramid structure for display by converting the setup image from an object image, in an object image format, included within a second image pyramid structure.

(21) An information processing apparatus, including:

a reception section configured to receive an output request asking for output of at least one of a plurality of first object images, the first object images being images of an object obtained by a microscope, the first object images being based on a first format and having different resolution;

an acquisition section configured to acquire at least one second object image, the second object image being based on a second format different from the first format and being obtained by the microscope;

a generation section configured to be able to generate the first object images based on the acquired second object image for the output of the first object image responding to the output request; and

a selection section configured to select at least one of the first object images generated by the generation section as a first setup image, the first setup image being generated irrespective of whether the output request is received, the remaining of the first object images being selected each as a second setup image generated in response to the reception of the output request.

(22) The information processing apparatus according to (21), in which

the selection section selects the first setup image to include at least any of the first object images having the lowest resolution.

(23) The information processing apparatus according to (21) or (22), in which

the selection section selects the second setup images to include at least any of the first object images having the highest resolution.

(24) The information processing apparatus according to any one of (21) to (23), in which

the generation section generates the first object images selected as the second setup images using a first generation pattern, the first generation pattern being based on the second object image with resolution equal to or higher than the resolution of the first object images.

(25) The information processing apparatus according to (24), in which

the generation section generates the first object images selected as the second setup images using a second generation pattern, the second generation pattern being based on the second object image with resolution equal to or lower than the first object images.

(26) The information processing apparatus according to (25), in which

the generation section makes a change between the first generation pattern and the second generation pattern in accordance with a mode related to the output of the first object image.

(27) The information processing apparatus according to any one of (21) to (26), in which

the acquisition section acquires a plurality of second object images with different resolution.

(28) The information processing apparatus according to (27), in which

the second object images include a reference image and a plurality of resolution-converted images, the reference image being for use as a reference, the resolution-converted images being results of converting resolution of the reference image.

(29) The information processing apparatus according to (27), in which

the second object images are captured at different magnifications.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image management apparatus comprising:
an image conversion section configured to generate a setup image, in a setup image format, within a first image pyramid structure for display, the setup image being converted from an object image, in an object image format, included within a second image pyramid structure in response to a request for the setup image.

2. The image management apparatus of claim 1, wherein the image conversion section is configured to generate a second setup image, in the setup image format, within the first image pyramid structure for display, the second setup image being converted from a second object image, in the object image format, included within the second image pyramid structure prior to the request for the setup image.

3. The image management apparatus of claim 2, wherein the setup image has a higher resolution than the second setup image.

4. The image management apparatus of claim 2, further comprising an information management section configured to store information indicative that the second setup image is to be generated prior to the request and the setup image is to be generated responsive to the request.

5. The image management apparatus of claim 4, wherein the information indicative that the second setup image is to be generated prior to the request includes a resolution threshold that indicates that setup images with resolutions less than the resolution threshold are to be generated prior to the request being received.

6. The image management apparatus of claim 2, wherein the image conversion section is configured to:
receive the object image from an acquisition section; and
generate the second image pyramid structure by creating at least the second object image by reducing a resolution of the object image and storing the object image and the second object image to the second image pyramid structure.

7. The image management apparatus of claim 6, wherein the object image is received responsive to an output from a digital optical microscope.

8. The image management apparatus of claim 2, wherein the image conversion section is configured to:
receive the object image and the second object image from an acquisition section; and
store the object image and the second object image to the second image pyramid structure.

9. The image management apparatus of claim 2, wherein the request includes an instruction to view at least a portion of the setup image at a higher resolution than the second setup image, wherein the portion is specified by coordinates of the second setup image.

10. The image management apparatus of claim 9, wherein the image conversion section is configured to generate the setup image from only the selected portion of the second setup image.

11. The image management apparatus of claim 2, wherein the image conversion section is configured to:
determine a client device is in a move browsing mode based information included within the request;
generate the second object image from the object image, the second object image having a greater resolution than the object image; and
generate the second setup image from the second object image before the request and the setup image from the second object image after the request.

12. The image management apparatus of claim 11, wherein the information included within the request includes coordinate information.

13. The image management apparatus of claim 2, wherein the image conversion section is configured to:
determine a client device is in a stop browsing mode based information included within the request;
generate the second object image from the object image, the second object image having a lower resolution than the object image; and
generate the second setup image from the second object image before the request and the setup image from the second object image after the request.

14. The image management apparatus of claim 2, wherein the image conversion section is configured to generate the setup image and the second setup image upon a conversion request from a client device.

15. The image management apparatus of claim 2, wherein the image conversion section is configured to generate a third setup image by reducing a resolution of the second setup image prior to the request.

16. The image management apparatus of claim 1, wherein the image conversion section is configured to generate the setup image by:
identifying an object image within the second image pyramid structure that has a greater resolution than the setup image, the identified object image being the object image;
reducing a resolution of the object image to a resolution specified for the setup image in the request; and
converting the reduced resolution version of the object image to the setup image format.

17. The image management apparatus of claim 16, wherein the image conversion section is configured to identify the object image by determining which object image within the second image pyramid structure has a nearest resolution to a resolution of the requested setup image.

18. A system comprising:
an image management apparatus configured to generate a setup image, in a setup image format, within a first image pyramid structure for display, the setup image being converted from an object image, in an object image format, included within a second image pyramid structure in response to a request for the setup image; and
an image browsing apparatus configured to:
transmit a request to the image management server for the setup image;
receive the setup image from the image management server; and
display the setup image.

19. An image browsing apparatus comprising:
a request generation section configured to transmit a request for a setup image, in a setup image format, within a first image pyramid structure, the request causing the setup image to be converted from an object image, in an object image format, included within a second image pyramid structure; and
a display section configured to display the received setup image.

20. A method to generate a setup image comprising:
receiving a request for a setup image from an image browsing apparatus; and
responsive to receiving the request, generating the setup image, in a setup image format, within a first image pyramid structure for display by converting the setup image from an object image, in an object image format, included within a second image pyramid structure.
